(19) United States
(12) Patent Application Publication
(10) Pub. No.: US 2017/0241882 A9
(43) Pub. Date: Aug. 24, 2017

(54) Automatic Stein Hall Viscosity Cup

(71) Applicants: William D. Stotler, Watsontown, PA (US); Mark J. Seksinsky, Watsontown, PA (US); Michael K. Pastore, Shamokin Dam, PA (US); Toby Murray, Montandon, PA (US)

(72) Inventors: William D. Stotler, Watsontown, PA (US); Mark J. Seksinsky, Watsontown, PA (US); Michael K. Pastore, Shamokin Dam, PA (US); Toby Murray, Montandon, PA (US)

(73) Assignee: Marquip, LLC, Phillips, WI (US)

(21) Appl. No.: 13/330,922

(22) Filed: Dec. 20, 2011

Related U.S. Application Data
(60) Provisional application No. 61/424,795, filed on Dec. 20, 2010.

(51) Int. Cl. G01N 11/02; G06F 19/00

(52) U.S. Cl. CPC G01N 11/06; G06F 19/00

(57) ABSTRACT

A Stein Hall cup for measuring the viscosity of a starch adhesive is automated to provide viscosity measurement in real time using a PLC or other data gathering and control processor. Temperature of the adhesive is measured concurrently with viscosity and temperature signals are processed with the timed viscosity signal to provide a temperature compensated value of starch viscosity.

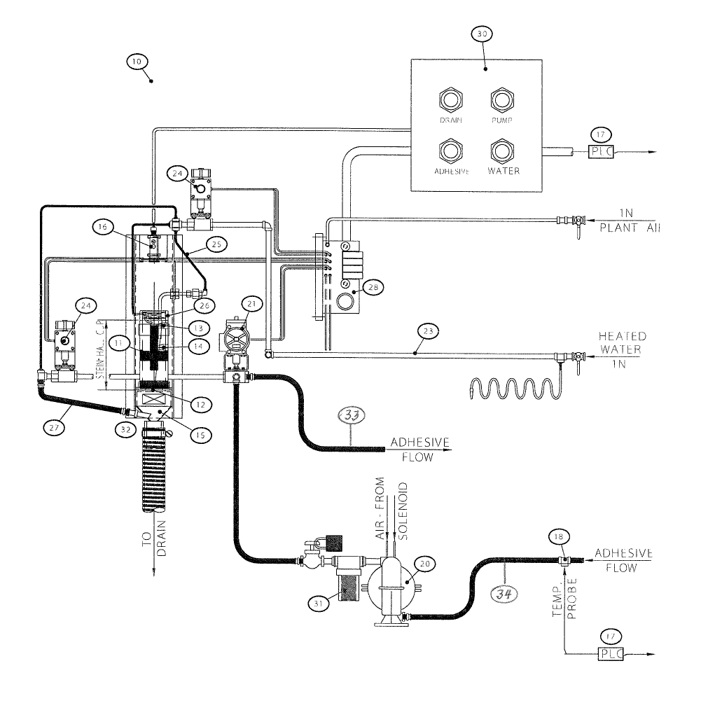

### CROSS REFERENCE TO RELATED APPLICATION

This application relates to and claims priority from U.S. Provisional Application Ser. No. 61/424,759 filed on Dec. 20, 2010.

### BACKGROUND

Presently, the majority of corrugators measure the viscosity of the starch adhesive using a Stein Hall cup. This device is equipped with two marker pins located at two levels. The bottom of the cup consists of an orifice plate with a hole. As the adhesive flows through the opening in the bottom, the time required for the adhesive to fall the measured difference between the two pins is related to the viscosity of the adhesive. The unit is expressed in seconds.

Historically, there have been numerous automatic viscometers used in the installed base, each type providing some number or measure of viscosity; however, few, if any, are able to correlated directly to the Stein Hall value due to the fact that this value relative to engineering units of actual viscosity is non-linear. Corrugator operators have always been accustomed to the Stein Hall value when making adjustments to the process or starch adhesive formulas.

Presently, the Stein Hall reading of viscosity is taken manually where the operator fills the cup with an adhesive sample, and using a stopwatch, takes the time required for the adhesive level in the cup to pass through the two marker pins in the side of the cup. Manual readings are subject to human error caused by the following, but not limited to, the condition of the cup and orifice, undispersed solids, and temperature difference between the cup and adhesive sample.

The automatic Stein Hall cup will provide an actual Stein Hall reading without the need to curve fit numbers normally produced by other automatic viscometers. The use of a programmable logic controller to initiate and record the viscosity provides flexibility and integration with the process alarming, data acquisition and recording and statistical process control.

Viscosity is one of the fundamental properties corrugating adhesive directly affecting the bonding process, corrugator operation, performance and efficiency. Corrugator operators and control systems must adjust corrugator settings and parameters for optimal process performance taking viscosity into account. Since this apparatus acquires viscosity data automatically through its PLC, this data is available in “real time” and can provide process variable inputs and directly interface with the corrugator's control system allowing adjustments to be made automatically and in real time. Additionally, this data may be logged in trending, SPC applications and other data acquisition systems.

The pin locations are spaced to define a volume in the cup of 100 cm³. Calibration of the cup is done by using water at 75° F. (23.9° C.) flowing through the orifice plate in 15 seconds. Viscosity is affected by changes in temperature. The viscosity is expressed in terms of the time in seconds for the starch adhesive to pass the 100 cm³ volume.

### SUMMARY

The invention provides an automatic apparatus and method of measuring the viscosity of a sample of starch adhesive. The apparatus includes a modified Stein Hall cup; however, the geometry in terms of the elevation of the measuring points, volume between the two marker pins, and the bottom orifice opening are identical to the standard Stein Hall cup used in manual measurements. The fluid mechanic and dynamic principles remain the same as the standard manual Stein Hall cup. The apparatus includes a laser level sensor that provides a non-invasive, non-contact sensor to detect two different levels of the adhesive sample. The apparatus contains nozzles and valves for washing and preheating the cup with warm water, a drain, and a port for filling with an adhesive sample. A programmable logic controller controls and sequences the preheating, adhesive prefill purge and sample fill pump. The laser level sensor will provide signals to the PLC when the level is at the two marker pins in the cup. As the adhesive sample flows through the bottom orifice, the PLC will record the time of efflux starting when the level passes the upper pin to the point when the level passes the lower pin. Upon conclusion of the measuring cycle, the drain port valve opens to discharge the remaining adhesive, and the wash nozzle valves will activate to rinse and flush the adhesive from the measuring cup.

### BRIEF DESCRIPTION OF THE DRAWING

The single drawing figure is a schematic representation of the system of the present invention for automatic real time measurement of viscosity of a liquid starch adhesive.

### DETAILED DESCRIPTION

The viscosity measuring system 10 is based on and uses a Stein Hall cup 11 used in the paper and paperboard industry for many years. As discussed above, the Stein Hall cup is supplied with liquid starch and the starch level in the cup is monitored as it moves downwardly by gravity through an orifice 12 in the cup. The time it takes for the surface of the starch to pass two vertically separated points, represented for example by an upper pin 13 and a lower pin 14 extending horizontally into the cup, provides a viscosity value. The adhesive sample moving downwardly past the pins 13, 14 passes through the orifice 12 and to a drain 15.

The system 10 of the present invention is adapted to minimize or virtually eliminate errors attributable to operator observation of the passage of the adhesive level past the upper and lower pins and the variations in adhesive viscosity resulting from temperature change. The accuracy of the change in adhesive level in the cup is determined by the use of a laser 16 which generates sequential time signals as the adhesive level drops in the cup 11 past the pins 13 and 14. The time signals for adhesive movement are directed to a programmable logic controller (PLC) 17 to generate a starch viscosity value.

Because the viscosity of the starch adhesive varies considerably with temperature, temperature of the adhesive is monitored with a temperature probe 18 which may be conveniently located at the inlet to an adhesive circulating pump 20. The adhesive temperature signal from the probe 18 is also directed to the PLC 17 where it is processed with the timed viscosity value signal to generate a temperature compensated starch viscosity.

It has been found that, as the cup is being initially filled with adhesive for testing, turbulence in the supply flow tends to generate bubbles in the adhesive over the top surface. Because the bubbles can interfere with proper operation of the laser, the cup 11 may be purposely overfilled until the level of the adhesive reaches the top of the cup and the bubbles are discharged.

Adhesive flow through the system is controlled by a solenoid-operated three-way pneumatic valve 21 that is operable to receive adhesive, via adhesive supply line 34, from the pump 20 and directed into the Stein Hall cup 11 or to recirculate the adhesive back to supply, via adhesive return line 33. The system also utilizes a water supply to direct water to the cup 11 for a number of purposes. The flow of water into the cup 11 is directed from water supply line 23 to a solenoid-operated three-way ball valve 24 from which the water is directed to a fill line 25 into the cup, a set of rinse nozzles 26 at the top of the cup, and a rinse line 27 to the drain 15. The water supply may be used to pre-heat the cup, to calibrate the cup as discussed above, and to rinse the cup and drain upon completion of an adhesive viscosity measurement.

The process controller is preferably programmed to generate a temperature compensated viscosity signal whenever an adhesive formula has been completed. In addition, the operator may manually introduce a liquid adhesive sample to the cup and operate the processor to generate a sample reading of temperature compensated viscosity.

When a viscosity measurement cycle has been completed, as by generating a lower pin level signal, the PLC operates to open a drain valve 32, followed by rinsing the remaining adhesive from the cup 11.

The system may conveniently utilize and air/solenoid bank 28 to distribute signals to and from the various valves, The system also preferably includes a control enclosure 30 to permit manual override, provide test access or provide off-line cleaning.

A strainer 31 may be positioned in the adhesive line downstream from the pump 20 to remove undispersed solids and the like that might interfere with adhesive flow and/or level detection in the cup.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A system for automatic real time measurement of the viscosity of liquid starch adhesive using a Stein Hall cup, wherein the liquid starch level in the cup is monitored as the starch moves downwardly by gravity through an orifice in the cup, and the time it takes for the surface of the starch to pass two vertically separated points in the cup provides a viscosity value; the improvement comprising:
a level sensor positioned over the starch level in the cup and operative to sense a beginning starch level and an ending starch level to determine a selected volume of starch leaving the cup;
a timer operative to generate a time signal representative of the starch viscosity value;
a temperature sensor operative to generate a starch temperature signal; and,
a data processor programmed to respond to the input of the time and temperature signals to generate an output of temperature compensated starch viscosity.

2. The system as set forth in claim 1, wherein the level sensor comprises a laser device.

3. The system as set forth in claim 2, wherein the laser device comprises a single laser mounted atop the cup and operable to sequentially generate beginning and ending starch level signals for input to the data processor.

4. The system as set forth in claim 3, wherein the data processor comprises a programmable logic controller.

5. The system as set forth in claim 1, including a first plumbed connection of the cup to an adhesive source, a second plumbed connection of the cup to a water supply, and a drain downstream of the orifice.

6. The system as set forth in claim 1, including an adhesive flow control in the first plumbed connection operative to supply an adhesive sample to the cup in response to a signal from the programmed controller.

7. The system as set forth in claim 6, including a water flow control in the second plumbed connection operative to supply rinse water to the cup in response to a signal from the programmed controller.

8. A method for automatic real time measurement of the viscosity of liquid starch adhesive using a Stein Hall cup, wherein the liquid starch level in the cup is monitored as the starch moves downwardly by gravity through an orifice in the cup, and the time it takes for the surface of the starch to pass two vertically separated points in the cup provides a viscosity value; the method comprising the steps of:
(1) positioning a level sensor above an upper level of starch in the cup;
(2) operating the sensor to sense a beginning starch level at the upper of the two points while draining the adhesive from the cup through the orifice;
(3) operating the sensor, while continuing the draining step, to sense an ending starch level at the lower of the two points;
(4) timing the movement of the starch level between the two points;
(5) measuring the temperature of the starch in the cup;
(6) generating signals representative of the timing and measuring steps; and,
(7) utilizing a programmable controller to process the timing and temperature signals to generate an output of temperature compensated starch viscosity.

9. The method as set forth in claim 8, wherein the positioning step utilizes a single laser sensor, and including the step of positioning the laser above an upper level of starch in the cup.

10. The method as set forth in claim 8, including the step of providing an adhesive flow control to supply an adhesive sample to the cup in response to a signal from the programmed controller.

11. The method as set forth in claim 10, including the step of providing a water flow control to supply rinse water to the cup in response to a signal from the programmed controller.

12. The method as set forth in claim 11, including the preliminary step of operating the adhesive flow control to overfill the cup and displace bubbles above the upper level.

13. The method as set forth in claim 8, wherein the programmed controller is operated to provide the temperature compensated viscosity upon completion of a starch formulation.

14. The method as set forth in claim 8, including the step of manually introducing an adhesive sample and utilizing the programmable controller to generate a sample output of temperature compensated starch viscosity.
